(19) United States
(12) Patent Application Publication
(10) Pub. No.: US 2018/0190097 A1
(43) Pub. Date: Jul. 5, 2018

(54) METHOD AND SMART WEARABLE DEVICE FOR CHILDREN'S SECURITY

(71) Applicant: JRD COMMUNICATION INC., Shenzhen, Guangdong (CN)

(72) Inventor: Yajun ZHU, Shenzhen, Guangdong (CN)

(73) Assignee: JRD COMMUNICATION INC., Shenzhen, Guangdong (CN)

(21) Appl. No.: 15/551,907

(22) PCT Filed: Nov. 18, 2016
(86) PCT No.: PCT/CN2016/106322

§ 371 Date: Aug. 18, 2017

(30) Foreign Application Priority Data
Apr. 25, 2016 (CN) 201610263730.X

(51) Int. Cl. G08B 21/02; H04L 29/06

(52) U.S. Cl. CPC G08B 21/0286; H04L 63/083; H04L 63/0861

(57) ABSTRACT

The present disclosure discloses a method and smart wearable device for children's security. The method includes: determining whether the smart wearable device receives the security authentication information; determining whether the smart wearable device is removed when the smart wearable device does not receive the security authentication information; sending location information and alarm information to a specified system when the smart wearable device is removed. Consequently, the present disclosure may help to prevent the wearer of the smart wearable device from being kidnapped by a stranger and thus ensure the wearer's security.

### CROSS-REFERENCE TO RELATED APPLICATIONS

The present application is a 35 U.S.C. § 371 National Phase conversion of International (PCT) Patent Application No. PCT/CN2016/106322 filed Nov. 18, 2016, which claims foreign priority of Chinese Patent Application No. 201610263730.X, filed on Apr. 25, 2016 in the State Intellectual Property Office of China, the contents of all of which are hereby incorporated by reference.

### TECHNICAL FIELD

The present disclosure generally relates to the field of wearable device, and in particular relates to a method and smart wearable device for children's security.

### BACKGROUND

Smart wearable device is a general term for wearable devices which are designed and developed intelligently by applying wearable technology on daily wear. A common smart wearable device is a smart watch or smart bracelet which has location function. It is usually worn by children to prevent them getting lost.

However, when the smart watch or smart bracelet is opened by a stranger, it is impossible to locate the child's position anymore, so that the problem may occur that the child may be kidnapped.

### SUMMARY

The present disclosure provides a method and smart wearable device for children's security, which helps to prevent the children from being kidnapped by a stranger and thus ensure the children's security.

In order to solve the above-mentioned technical problem, one technical scheme adopted by the present disclosure is to provide a smart wearable device, wherein the smart wearable device includes: a processor, a memory coupled with the processor, a receiver and a transmitter; the memory is configured to store program instructions; the receiver is configured to receive security authentication information; the transmitter is configured to send location information and alarm information; the processor is configured to execute program instructions in order to determine whether the receiver receives security authentication information; the processor is configured to further determine whether the smart wearable device is removed when the receiver does not receive security authentication information; the processor is configured to send location information and alarm information to a specified system when the smart wearable device is removed.

In one embodiment, the instructions executed by the processor for determining whether the smart wearable device is removed may include: the processor determines whether the electric circuit of the smart wearable device is interrupted; and if so, the processor determines that the smart wearable device is removed.

In one embodiment, the smart wearable device may further include a loudspeaker. When the smart wearable device is removed, the processor is further configured to command the loudspeaker to raise a sound alarm to warn the person who has removed the smart wearable device and persons nearby.

In one embodiment, if the receiver receives the security authentication information, the processor may be further configured to compare the received security authentication information with pre-set security authentication information; if the received security authentication information is consistent with the pre-set security authentication information, allow the smart wearable device to be removed; and if not, send location information and alarm information to the specified system; wherein, in the case that the security authentication information includes fingerprint information, if the received fingerprint information is not consistent with the pre-set fingerprint information, the transmitter sends location information, alarm information and received fingerprint information to the specified system.

In one embodiment, the pre-set security authentication information may include fingerprint information of a relative of the child wearing the smart wearable device and/or a pre-set password.

In order to solve the above-mentioned technical problem, a second technical scheme adopted by the present disclosure is to provide a method for children's security, including: determining whether the smart wearable device receives security authentication information; if the security authentication information is not received, further determining whether the smart wearable device is removed; if the smart wearable device is removed, sending location information and alarm information to a specified system.

In one embodiment, the method to determine whether the smart wearable device is removed may include: determining whether the electric circuit of the smart wearable device is interrupted; and if so, concluding that the smart wearable device is removed.

In one embodiment, when the smart wearable device is removed, the method may further include: raising a sound alarm to warn the person who has removed the smart wearable device and persons nearby.

In one embodiment, if the smart wearable device receives the security authentication information, the method may further include: comparing the received security authentication information with pre-set security authentication information; if the received security authentication information is consistent with the pre-set security authentication information, allowing the smart wearable device to be removed; and if not, sending location information and alarm information to the specified system; wherein, in the case that the security authentication information includes fingerprint information, if the received fingerprint information is not consistent with the pre-set fingerprint information, the smart wearable device sends location information, alarm information and received fingerprint information to the specified system.

In one embodiment, the pre-set security authentication information may include fingerprint information of a relative of the child wearing the smart wearable device and/or a pre-set password.

In order to solve the above-mentioned technical problem, a third technical scheme adopted by the present disclosure is to provide a smart wearable device which may include: a first judgment module set inside the smart wearable device, configured to determine whether the smart wearable device receives the security authentication information; a second judgment module set inside the smart wearable device, connected with the first judgment module, configured to determine whether the smart wearable device is removed when the first judgment module determines that the smart wearable device does not receive the security authentication information; a processing module set inside the smart wearable device, connected with the second judgment module, configured to send location information and alarm information to a specified system when the second judgment module determines that the smart wearable device is removed.

In one embodiment, the method by which the second judgment module determines whether the smart wearable device is removed may include: determining whether the electric circuit of the smart wearable device is interrupted.

In one embodiment, when the second judgment module determines that the smart wearable device is removed, the processing module may also be utilized to raise a sound alarm to warn the person who has removed the smart wearable device and persons nearby.

In one embodiment, the smart wearable device may further include one comparison module, the comparison module is set inside the smart wearable device, connected with the first judgment device, and configured to compare the received security authentication information with the pre-set security authentication information when the first judgment module determines that the smart wearable device has received the security authentication information. If the comparison module determines that the received security authentication information is consistent with the pre-set security authentication information, the processing module allows the smart wearable device to be removed, and if not, the processing module sends location information and alarm information to the specified system. Wherein, in the case that the security authentication information includes fingerprint information, if the comparison module determines that the received fingerprint information is not consistent with the pre-set fingerprint information, the processing module may send location information, alarm information and received fingerprint information to the specified system.

In one embodiment, the pre-set security authentication information may include fingerprint information of a relative of the child wearing the smart wearable device and/or a pre-set password.

An advantageous effect of the present disclosure is: in contrast to the prior art, the present disclosure is able to determine whether a smart wearable device receives security authentication information, to further determine whether the smart wearable device is removed if the security authentication information is not received, and to send location information and alarm information to a specified system. Consequently, the present disclosure may help to prevent the children from being kidnapped by a stranger and thus ensures the children's security.

### BRIEF DESCRIPTION OF THE DRAWINGS

FIG. 1 is a flow chart of one embodiment of a method for children's security of the present disclosure.

FIG. 2 is a schematic diagram of one embodiment of a smart wearable device of the present disclosure.

FIG. 3 is a schematic diagram of one embodiment of a specific device of a smart wearable device of the present disclosure.

### DETAILED DESCRIPTION

The disclosure will now be described in detail with reference to the accompanying drawings and examples.

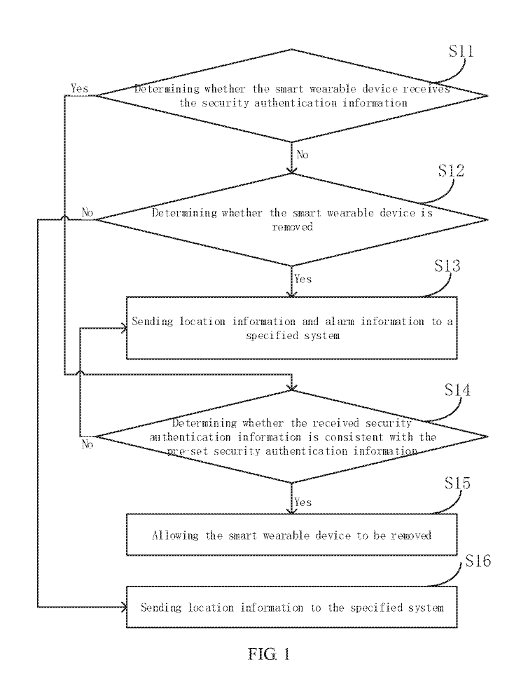

Referring to FIG. 1, a flow chart of one embodiment of a method and smart wearable device for children's security of the present disclosure is depicted. It is to be understood that, the method of the present disclosure is not limited by the flow chart shown in FIG. 1 if other embodiments have substantially the same result. The method may include the following blocks.

S11: determining whether the smart wearable device receives security authentication information, if not, enter block S12, otherwise enter block S14.

At S11, when the smart wearable device includes a fingerprint input device, the security authentication information may be fingerprint information. When the smart wearable device includes a password input device, the security authentication information may be a password. When the smart wearable device includes a fingerprint input device and a password input device, the security authentication information may include both of the fingerprint information and the password.

S12: determining whether the smart wearable device is removed, if yes, enter block S13, otherwise enter block S16.

At S12, the operations to determine whether the smart wearable device is removed may specifically include: determining whether the electric circuit of the smart wearable device is interrupted. Wherein, when the electric circuit of the smart wearable device is interrupted, it can be determined that the smart wearable device is removed. In other words, in condition that the smart wearable device does not receive the security authentication information, if the electric circuit of the smart wearable device is interrupted, it means that the smart wearable device is forcibly removed by a stranger.

In other embodiments, the operations to determine whether the smart wearable device is removed may include: using a sensor to determine whether the latch of the smart wearable device is unlocked. Wherein, when the latch is unlocked, it can be determined that the smart wearable device is removed. In other words, in condition that the smart wearable device does not receive the security authentication information, if the latch is unlocked, it means that the smart wearable device is forcibly removed by a stranger.

S13, sending location information and alarm information to a specified system.

At S13, in condition that the smart wearable device does not receive the security authentication information, when the smart wearable device is forcibly removed by a stranger or strangers, the smart wearable device sends location information and alarm information to the specified system. Wherein, the specified system may be several mobile terminals which have a wireless connection with the smart wearable device, the mobile terminals may be the mobile terminals of the relative(s) of the child wearing the smart wearable device, e.g. parents, grand-parents or other guardians.

That is to say, when a stranger forcibly removes the smart wearable device from the child, the mobile terminal(s) of the child's relative(s) can receive the smart wearable device's location information and alarm information so that the child's relative(s) may take action immediately, which reduces the possibility of the child being kidnapped.

In one embodiment, in order to ensure that the relatives of the child wearing the smart wearable device arrive at the scene immediately, while the smart wearable device sends location information and alarm information to the specified system, the smart wearable device may also be capable of raising a sound alarm to warn the person who has removed the smart wearable device and the persons nearby, which further reduces the possibility of the child being kidnapped.

S14, determining whether the received security authentication information is consistent with the pre-set security authentication information, if so, enter block S15, otherwise enter block S13.

At S14, the pre-set security authentication information is pre-set fingerprint information of the relative(s) of the child wearing the smart wearable device, and/or a pre-set password.

That is to say, if the smart wearable device includes only a fingerprint input device, the smart wearable device compares the received fingerprint information with the pre-set fingerprint information of the relative(s) of the child wearing the smart wearable device. If the smart wearable device includes only a password input device, the smart wearable device compares the received password with the pre-set password. If the smart wearable device includes a fingerprint input device and a password input device, the smart wearable device compares the received fingerprint information with the pre-set fingerprint information of the relative(s) of the child wearing the smart wearable device and also compares the received password with the pre-set password, so that the difficulty of removing the smart wearable device may be increased and the security may be improved.

When the received security authentication information is not consistent with the pre-set security authentication information, block S13 is executed, in which the smart wearable device may send location information and alarm information to the specified system. In one embodiment, in the case that the smart wearable device is equipped with a fingerprint input device, in other words, the security authentication information includes fingerprint information, when the received fingerprint information is not consistent with the pre-set fingerprint information, the smart wearable device may send location information, alarm information and the received fingerprint information to the specified system. Wherein, sending the received fingerprint information to the specified system helps the police to search and identify the relative person afterwards on using the received fingerprint information, therefore the possibility of the child being kidnapped is reduced.

In one embodiment, in order to reduce false alarms caused by input mistakes, when the received security authentication information is not consistent with the pre-set security authentication information, the smart wearable device may inform the user to input again the security authentication information and then record the number of inputs. When the number of inputs exceeds the pre-determined value (e.g. 3 times), the smart wearable device sends location information and alarm information to the specified system. When the number of inputs does not exceed the predetermined value (e.g. 3 times), the smart wearable device may continue to receive received security authentication information and then compare it with the pre-set security authentication information.

S15, allowing the smart wearable device to be removed.

At S15, allowing the smart wearable device to be removed when the received security authentication information is consistent to the pre-set security authentication information may include: the smart wearable device interrupts automatically the electric circuit and waits for user to remove the smart wearable device, and if the smart wearable device is removed on this condition, the smart wearable device does not sent location information nor alarm information to the specified system.

S16, sending location information to the specified system.

At S16, when the smart wearable device does not receive the security authentication information and the smart wearable device is not removed, the smart wearable device sends location information to the specified system.

It is to be understood that, after the smart wearable device being worn normally, the process mentioned in S16 may be executed periodically so that it will be more difficult for a stranger to kidnap the child wearing the smart wearable device.

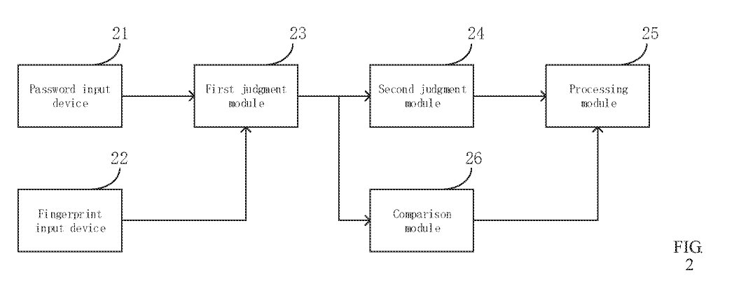

Referring to FIG. 2, a schematic diagram of one embodiment of a smart wearable device of the present disclosure. As shown in FIG. 2, the smart wearable device comprises a password input device 21, a fingerprint input device 22, a first judgment module 23, a second judgment module 24, a processing module 25 and a comparison module 26.

The password input device 21 set in the smart wearable device, may be configured to receive the security authentication information, namely the password.

The fingerprint input device 22 set in the smart wearable device, may be configured to receive the security authentication information, namely the fingerprint information.

It is to be understood that, in this embodiment, the smart wearable device includes not only the password input device 21 but also the fingerprint input device 22. In other embodiments, the smart wearable device may comprise merely the password input device 21 or the fingerprint input device 22.

A first judgment module 23 set in the smart wearable device, connected to the password input device and the fingerprint input device, may be configured to determine whether the smart wearable device receives the security authentication information, in other words, whether the password input device 21 and the fingerprint input device 22 receive respectively the password and the fingerprint information.

A second judgment module 24 set in the smart wearable device, connected with the first judgment module 23, may be configured to determine whether the smart wearable device is removed when the first judgment module 23 determines that the smart wearable device does not receive the security authentication information.

The operations executed by the second judgment module 24 to determine whether the smart wearable device is removed may comprise: the second judgment module 24 determines whether the electric circuit of the smart wearable device is interrupted. Wherein, when the second judgment module 24 detects that the electric circuit of the smart wearable device is interrupted, the second judgment module 24 determines that the smart wearable device is removed.

The processing module 25 set inside the smart wearable device, connected with the second judgment module 24, may be configured to send location information and alarm information to the specified system when the second judgment module 24 determines that the smart wearable device is removed.

The comparison module 26 set inside the smart wearable device, connected with the first judgment module 23, may be configured to compare the received security authentication information with the pre-set security authentication information when the first judgment module 23 detects that the smart wearable device receives the security authentication information.

In this embodiment, the pre-set security authentication information is pre-set fingerprint information of the relative(s) of the child wearing the smart wearable device and a pre-set password.

In other embodiments, if the smart wearable device includes only the password input device, the pre-set security authentication information is a pre-set password; if the smart wearable device includes only the fingerprint input device, the pre-set security authentication information is pre-set fingerprint information of the relative(s) of the child wearing the smart wearable device.

In one embodiment, when the comparison module 26 determines that the received security authentication information is consistent with the pre-set security authentication information, the processing module 25 allows the smart wearable device to be removed.

In one embodiment, when the comparison module 26 determines that the received security authentication information is not consistent with the pre-set security authentication information, the processing module 25 sends location information and alarm information to the specified system. In one embodiment, in the case that the security authentication information includes fingerprint information, when the comparison module 26 determines that the received fingerprint information is not consistent with the pre-set fingerprint information, the processing module 25 sends location information, alarm information and received fingerprint information to the specified system.

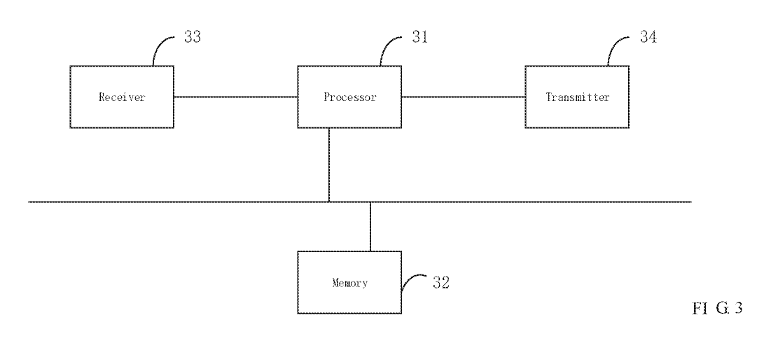

Referring to FIG. 3, a schematic diagram of one embodiment of a specific device of a smart wearable device of the present disclosure. The specific device is capable of executing the blocks as set forth above, related information can be found in the above-mentioned method and will not be described hereon.

The specific device may include: a processor 31, a memory 32 coupled with the processor 31, a receiver 33 and a transmitter 34.

The memory 32 may be configured to store program instructions; the receiver may be configured to receive security authentication information; the transmitter may be configured to send location information and alarm information.

The processor 31 may be configured to: determine whether the receiver 33 receives the security authentication information; determine whether the smart wearable device is removed when the receiver 33 does not receive the security authentication information; send location information and alarm information to a specified system if the smart wearable device is removed.

In this embodiment, the receiver 33 includes a password input device and a fingerprint input device. The operations executed by the processor 31 to determine whether the receiver 33 receives the security information may include: the processor 31 determines whether the password input device receives a received password and whether the fingerprint input device receives received fingerprint information.

The method by which the processor 31 determines whether the smart wearable device is removed may specifically include: the processor 31 determines whether the electric circuit of the smart wearable device is interrupted. When the electric circuit of the smart wearable device is interrupted, it is determined that the smart wearable device is removed.

When the smart wearable device is removed, the processor 31 may also be utilized to raise a sound alarm to warn the person who has removed the smart wearable device and the persons nearby.

In the case that the receiver 33 receives security authentication information, the processor 31 may also be configured to compare the received security authentication information with the pre-set security authentication information. If the received security authentication information is consistent with the pre-set security authentication information, the processor 31 allows the smart wearable device to be removed. And if not, the processor 31 sends location information and alarm information to a specified system. Wherein, in the case that the security authentication information includes fingerprint information, when the received fingerprint information is not consistent with the pre-set fingerprint information, the transmitter 34 sends location information, alarm information and the received fingerprint information to a specified system.

In one embodiment, the pre-set security authentication information may be pre-set fingerprint information of a relative of the child wearing the smart wearable device and/or a pre-set password.

It is to be understood that, in this embodiment, the receiver 33 comprises not only the password input device but also the fingerprint input device. In other embodiments, the smart wearable device may comprise only the password input device or the fingerprint input device.

When the receiver 33 includes merely the password input device, the pre-set security information is a pre-set password. When the receiver 33 includes merely the fingerprint input device, the pre-set security information is the pre-set finger print information of the relative(s) of the child wearing the smart wearable device.

An advantageous effect of the present disclosure is: in contrast to the prior art, the method and smart wearable device for children's security of the present disclosure may send location information to a specified system when the smart wearable device is worn normally, and send location information and alarm information to a specified system when the smart wearable device is removed without correct security authentication. Consequently, the present disclosure may help to prevent the children from being kidnapped by a stranger and thus ensures the children's security.

It is to be understood that, the systems, apparatus and methods disclosed in the embodiments of the present disclosure may be implemented by other means. For instance, the embodiment of a specific device is just representative. For instance, the division of the above-mentioned modules and units depends on logical functions, and in practical implementation it may have another way of division. For instance, several components may be combined or integrated in other systems, and some blocks may be ignored or not be executed. Besides, the coupling, direct connection and communication connection may utilize some connectors, indirect connection or communication connection between devices or units, and may be electrical, mechanical or of other forms.

The devices and units above-described separately may or may not be physically independent. The components shown as units may or may not be physical units, that is to say, the components may be located in the same place, or be distributed over multiple network elements. It is possible to choose a portion or all of the units according to actual needs to achieve the functions of the present embodiment.

In addition, the functional units of different embodiments of the present disclosure may be integrated in one processing unit, or be several separate physical elements, or be integrated in different units. The different integration forms mentioned above may be implemented either in the form of hardware or software functional units.

When implemented in the form of software functional units and utilized and sold independently, the above-mentioned integrated units may be stored in the ROM of a computer. Based on this comprehension, the parts which contribute to the prior art or all of the embodiments of the present disclosure may be implemented in the form of software product, and the software product may be stored in a storage medium comprising several instructions which is configured to execute all or part of the blocks described in the above-mentioned embodiments of the present disclosure on a computer equipment (which may be a personal computer, a server or a network equipment etc.) or on a processor. The above-mentioned storage medium may include: USB flash disk, mobile HDD, ROM, RAM, disk or any medium used for storing program code.

The above-described embodiments are intended to illustrate rather than limit the present disclosure. Equivalent structure or equivalent process transformation based on the specification of the disclosure are likewise included within the scope of patent protection of the present disclosure, either utilized directly or indirectly in the relative technical field.

1. A smart wearable device, comprising: a processor, a memory coupled with the processor, a receiver and a transmitter, wherein:
the memory is configured to store program instructions;
the receiver is configured to receive security authentication information;
the transmitter is configured to send location information and alarm information;
the processor, when executing the program instructions, is configured to:
determine whether the receiver receives the security authentication information;
determine whether the smart wearable device is removed when the receiver does not receive the security authentication information; and
inform the transmitter to send the location information and the alarm information to a specified system when the smart wearable device is removed.

2. The device of claim 1, wherein the operation executed by the processor to determine whether the smart wearable device is removed comprises:
the processor determines whether an electric circuit of the smart wearable device is interrupted; and
the processor determines the smart wearable device is removed when the electric circuit of the smart wearable device is interrupted.

3. The device of claim 1, wherein the processor is further configured to raise a sound alarm to warn a person who has removed the smart wearable device and persons near the smart wearable device.

4. The device of claim 1, wherein when the receiver receives the security authentication information, the processor is further configured to:
compare the received security authentication information with pre-set security authentication information;
allow the smart wearable device to be removed when the received security authentication information is consistent with the pre-set security authentication information; and
send the location information and the alarm information to the specified system when the received security authentication information is not consistent with the pre-set security authentication information.

5. (canceled)

6. A child security method for a smart wearable device, comprising:
determining whether the smart wearable device receives security authentication information;
further determining whether the smart wearable device is removed when the smart wearable device does not receive the security authentication information;
sending location information and alarm information to a specified system when the smart wearable device is removed.

7. The method of claim 6, wherein the determining whether the smart wearable device is removed comprises:
determining whether an electric circuit of the smart wearable device is interrupted;
determining that the smart wearable device is removed when the electric circuit of the smart wearable device is interrupted.

8. The method of claim 6, when the smart wearable device is removed, further comprising:
raising a sound alarm by the smart wearable device to warn a person who has removed the smart wearable device and persons near the smart wearable device.

9. The method of claim 6, when the smart wearable device receives the security authentication information, further comprising:
comparing the received security authentication information with pre-set security authentication information;
allowing the smart wearable device to be removed when the received security authentication information is consistent with the pre-set security authentication information; and
sending location information and alarm information to the specified system when the received security authentication information is not consistent with the pre-set security authentication information.

10.-15. (canceled)

16. The device of claim 4, wherein:
the receiver comprises a password input device;
the pre-set security authentication information comprises a pre-set password; and
the received security authentication information comprises a received password.

17. The device of claim 4, wherein:
the receiver comprises a fingerprint input device;
the pre-set security authentication information comprises pre-set fingerprint information;
the received security authentication information comprises received fingerprint information; and
the processor is further configured to send the received fingerprint information to the specified system when the received fingerprint information is not consistent with the pre-set fingerprint information.

18. The device of claim 1, wherein the processor is further configured to command the transmitter to send the location information to the specified system periodically when the smart wearable device is not removed.

19. The method of claim 9, wherein the pre-set security authentication information comprises a pre-set password.

20. The method of claim 9, wherein,
the pre-set security authentication information comprises pre-set fingerprint information;
the received authentication information comprises received fingerprint information; and
the method further comprises sending the received fingerprint information to the specified system when the received fingerprint information is not consistent with the pre-set fingerprint information.

21. The method of claim 6, further comprising sending the location information to the specified system periodically when the smart wearable device is not removed.

22. A non-transitory computer-readable medium comprising computer-executable instructions that, when executed by a processor, cause the processor to perform a child security method for a smart wearable device, the method comprises:
determining whether the smart wearable device receives security authentication information;
further determining whether the smart wearable device is removed when the smart wearable device does not receive the security authentication information;
sending location information and alarm information to a specified system when the smart wearable device is removed.

23. The non-transitory computer-readable medium of claim 22, wherein the method further comprises:
determining whether an electric circuit of the smart wearable device is interrupted;
determining that the smart wearable device is removed when the electric circuit of the smart wearable device is interrupted.

24. The non-transitory computer-readable medium of claim 22, wherein the method further comprises raising a sound alarm to warn a person who has removed the smart wearable device and persons near the smart wearable device.

25. The non-transitory computer-readable medium of claim 22, wherein the method further comprises:
comparing the received security authentication information with pre-set security authentication information;
allowing the smart wearable device to be removed when the received security authentication information is consistent with the pre-set security authentication information; and
sending the location information and the alarm information to the specified system when the received security authentication information is not consistent with the pre-set security authentication information.

26. The non-transitory computer-readable medium of claim 25, wherein:
the pre-set security authentication information comprises pre-set fingerprint information of a relative of a child wearing the smart wearable device;
the received security authentication information comprises received fingerprint information; and
the method further comprises sending the received fingerprint information to the specified system when the received fingerprint information is not consistent with the pre-set fingerprint information.

27. The non-transitory computer-readable medium of claim 22, wherein the method further comprises sending the location information to the specified system periodically when the smart wearable device is not removed.
